(19) United States
(12) Patent Application Publication
(10) Pub. No.: US 2024/0243537 A1
(43) Pub. Date: Jul. 18, 2024

(54) Small sliding multiple plug

(71) Applicant: Guangli ZENG, Bazhong City (CN)

(72) Inventors: Guangli ZENG, Bazhong City (CN); Chengbing WANG, Bazhong City (CN); Feng WANG, Bazhong City (CN)

(21) Appl. No.: 18/617,494

(22) Filed: Mar. 26, 2024

Related U.S. Application Data
(63) Continuation of application No. 17/753,551, filed on Mar. 7, 2022.

(51) Int. Cl. H01R 31/06; H01R 13/04; H01R 13/629; H01R 13/68; H01R 24/68

(52) U.S. Cl. CPC H01R 31/065; H01R 13/04; H01R 13/629; H01R 13/68; H01R 24/68

(57) ABSTRACT

The present invention discloses a small sliding multiple plug, comprising a housing, and a plurality of pin holes arranged on the bottom surface of the housing, wherein a first pin, a second pin and a third pin are arranged in the housing; the first pin mainly consists of a ground line leg, a live line leg and a null line leg; when the ground line leg of the first pin is taken as a central point, the second pin is arranged on one side of the central point, and the third pin is arranged on the other side of the central point; and the second pin and the third pin are respectively composed of three legs including the ground line leg. The present invention provides a small sliding multiple plug, which is small in size, has high safety in use, and meets the requirements of safety standards and developing to miniaturization.

### CROSS REFERENCES TO RELATED APPLICATION

This application is a continuation of U.S. application Ser. No. 17/753,551, entitled “Small sliding multiple plug”, filed Mar. 7, 2022, and the entire contents of which are incorporated herein by reference.

### TECHNICAL FIELD

The present invention relates to the field of power converters, and more particularly to a small sliding multiple plug.

### BACKGROUND ART

Since the standards for the sockets in each country are not completely uniform, a plug cannot be universally used all over the world. When people go to different countries, it is necessary to configure a plug corresponding to the country so as to supply power for portable electronic devices. If going to several countries at a time, consumers have to take power plugs corresponding to several countries, which causes great trouble for people who travel across countries or have a business travel.

As a result, multi-national power plugs are commonly available on the market that can be adapted to different national socket standards. It is disclosed in Chinese patent for invention (Patent No: 201010183801.8) that a plurality of pins 30 of different specifications are grouped on the same power converter. However, the two groups of pins, American (US) pins 301 and Australian (AU) pin 304, have only two legs, i. e. without ground pins. Although this power converter reduces the internal volume when reducing the number of legs, it has the risk of electric shock and leakage when used in high-power electrical appliances, which has low safety and does not meet the safety standards.

At the same time, the Chinese patent document for invention (Patent No: 200980132171.7), discloses multiple groups of conductive pins respectively containing three pins, wherein the multiple groups of conductive pins are arranged successively along one direction, so that the multiple groups of conductive pins occupy a large space, resulting in a large volume of the whole product. It cannot realize the development of the product to be miniaturized and is not convenient to carry the product.

It can be seen from the above that, for the existing multi-national power plugs, it is impossible to meet the requirements of meeting the safety standards and developing towards miniaturization at the same time.

### SUMMARY OF THE INVENTION

In view of the above-mentioned disadvantages, it is an object of the present invention to provide a small sliding multiple plug, which is small in size, has high safety in use, and meets the requirements of safety standards and developing to miniaturization.

The technical solution adopted by the invention for achieving the above purpose is as follows.

A small sliding multiple plug comprises a housing, and a plurality of pin holes arranged on the bottom surface of the housing, characterized in that a first pin, a second pin and a third pin are arranged in the housing; the first pin mainly consists of a ground line leg, a live line leg and a null line leg; when the ground line leg of the first pin is taken as a central point, the second pin is arranged on one side of the central point, and the third pin is arranged on the other side of the central point; and the second pin and the third pin are respectively composed of three legs including the ground line leg.

As a further improvement of the invention, at least one retaining wall is extended in the housing on the side of at least one of the first pin, the second pin and the third pin.

As a further improvement of the invention, the second pin and the third pin are both located on the upper sides of the live line leg and the null line leg of the first pin.

As a further improvement of the invention, the first pin is T-shaped; the second pin is C-shaped, L-shaped or O-shaped; and the third pin is C-shaped, L-shaped, D-shaped or O-shaped.

As a further improvement of the invention, a fuse is arranged in the housing among the three legs of the third pin.

As a further improvement of the invention, the first pin is a UK standard of pin; the second pin is a US standard of pin; and the third pin is an AU standard of pin or a CN standard of pin.

As a further improvement of the present invention, the pin hole comprises a first leg hole through which a live line leg passes, a second leg hole through which a null line leg passes, and a third leg hole through which a ground line leg passes; the third leg hole is perpendicularly arranged at one side of the middle point of the first leg hole and the second leg hole; a bottom surface of the housing comprises a first bottom edge, a second bottom edge and a third bottom edge, wherein a first region is constituted by the first bottom edge, a second bottom edge, a parallel line passing through the first leg hole and being parallel to the first bottom edge, and a parallel line passing through the third leg hole and being parallel to the second bottom edge; a second region is constituted by the first bottom edge, a third bottom edge, a parallel line passing through the second foot hole and being parallel to the first bottom edge, and a parallel line passing through the third foot hole and being parallel to the third bottom edge; the first region and the second region are respectively provided on both sides of the ground line leg; the second pin and the corresponding pin hole are arranged in the first region, and the third pin and the corresponding pin hole are arranged in the second region; the second pin comprises a fourth leg, a fifth leg and a sixth leg, and at least one of the fourth leg, the fifth leg and the sixth leg is a ground line leg; the third pin comprises a seventh leg, an eighth leg and a ninth leg, wherein at least one of the seventh leg, the eighth leg and the ninth leg is a ground line leg; and positioning guide seats are provided in the housing to match the first pin, the second pin and the third pin, respectively.

As a further improvement of the invention, the fourth leg is directed towards a midpoint of the first leg hole and the second leg hole; and the ninth leg is directed towards a midpoint of the first leg hole and the second leg hole.

As a further improvement of the present invention, the first pin further comprises a UK standard of sliding piece and a UK standard of pin seat, wherein the UK standard of pin seat is provided with a UK standard of clamping mechanism and a UK standard of return spring, and the UK standard of sliding piece is clamped and movable in the UK standard of clamping mechanism; the UK standard of sliding piece and the UK standard of pin seat are provided with a UK standard of positioning hole; a UK standard of limiting guide post is provided at a corresponding position of the positioning guide seat; and the pushing-out and pushing-in of the first pin is controlled by the matching of the UK standard of positioning hole and the UK standard of limiting guide post.

As a further improvement of the present invention, the second pin comprises a US standard of sliding piece and a US standard of pin seat; the US standard of pin seat is provided with a US standard of clamping mechanism and a US standard of return spring; the US standard of sliding piece is clamped and movable in the US standard of clamping mechanism; the US standard of sliding piece and the US standard of pin seat are provided with a US standard of positioning hole; a US standard of limiting guide post is provided at a corresponding position of the positioning guide seat; and the pushing-out and pushing-in of the second pin is controlled by the matching of the US standard of positioning hole and the US standard of limiting guide post.

As a further improvement of the present invention, the third pin comprises an AU-CN sliding piece and an AU-CN pin seat; the AU-CN pin seat is provided with an AU-CN clamping mechanism and an AU-CN return spring; the AU-CN sliding piece is clamped and movable in the AU-CN clamping mechanism; the AU-CN sliding piece and the AU-CN pin seat are provided with an AU-CN positioning hole; an AU-CN limiting guide post is provided at a corresponding position of the positioning guide seat; and the pushing-out and pushing-in of the third pin is controlled by the matching of the AU-CN positioning hole and AU-CN limiting guide post.

The invention has the following beneficial effects.
(1) By arranging the US standard of pin and the AU standard (or CN standard) of pin at the two shoulders of the UK standard of pin at the same time, this part of space is effectively used, so that the volume of the small plug of the whole converter can be further reduced, facilitating the development of the product to be miniaturized and convenient to carry. Meanwhile, the US standard of pin, the AU standard (or CN standard) of pin and the UK standard of pin all contain the ground line leg. When they are used in high-power electrical appliances, there is no risk of electric shock and leakage, with high safety, which meets the safety standards. Therefore, the use safety is improved while the product is miniaturized.
(2) By adding a retaining wall on the side of at least one of the first pin, the second pin and the third pin, two legs are spaced apart by the retaining wall, so that the creepage distance between the two legs increases, thereby increasing the electric clearance between the two legs. It is ensured that the clearance between each two legs can meet the electric clearance of the safety standard. Thus, the entire product has both advantages of meeting the safety standard and being small in size, so that the product can be miniaturized while meeting the safety standard.
(3) By adding a fuse in the housing with a small limited space and arranging it skillfully among the three legs of the third pin, the electric safety is further improved and meets the safety standards on the basis of ensuring the overall miniaturization of the product.

The above is an overview of the technical scheme of the invention. The following is a further explanation of the invention in combination with the attached drawings and specific implementations.

### BRIEF DESCRIPTION OF THE DRAWINGS

FIG. 1 is a structurally schematic view of a pin hole when only a first pin is formed on the bottom surface of a housing according to the present invention;

FIG. 2 is a structurally schematic view of a pin hole when the bottom surface of a housing of the present invention comprises a first pin, a second pin and a third pin;

FIG. 3 is a structurally schematic view of a positioning guide seat of the present invention;

FIG. 4 is a schematic view showing a mounting structure of a first pin, a second pin and a third pin according to the present invention;

FIG. 5 is a structurally schematic view showing the arrangement of a retaining wall according to the present invention;

FIG. 6 is a schematic view showing the overall structure of a first pin according to the present invention;

FIG. 7 is a schematic view showing an explosion structure of a first pin according to the present invention;

FIG. 8 is a schematic view showing an overall structure of a second pin according to the present invention;

FIG. 9 is a schematic view of an explosion structure of a second pin according to the present invention;

FIG. 10 is a schematic view showing the overall structure of a third pin according to the present invention;

FIG. 11 is a schematic view showing an explosion structure of a third pin according to the present invention;

FIG. 12 is a structurally schematic view of a possible configuration way of a pin of the present invention;

FIG. 13 is a structurally schematic view in which a pin has other shapes according to the present invention;

FIG. 14 is a structurally schematic view in which a fuse is provided in a third pin according to the present invention.

### DETAILED DESCRIPTION OF THE INVENTION

In order to further explain the technical means and effects of the present invention for achieving the intended purpose, the following detailed description of the embodiments of the present invention will be made with reference to the accompanying drawings and preferred embodiments.

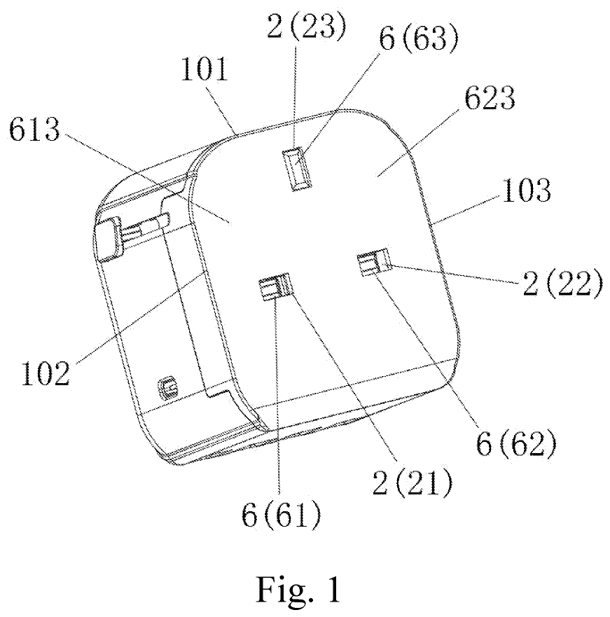

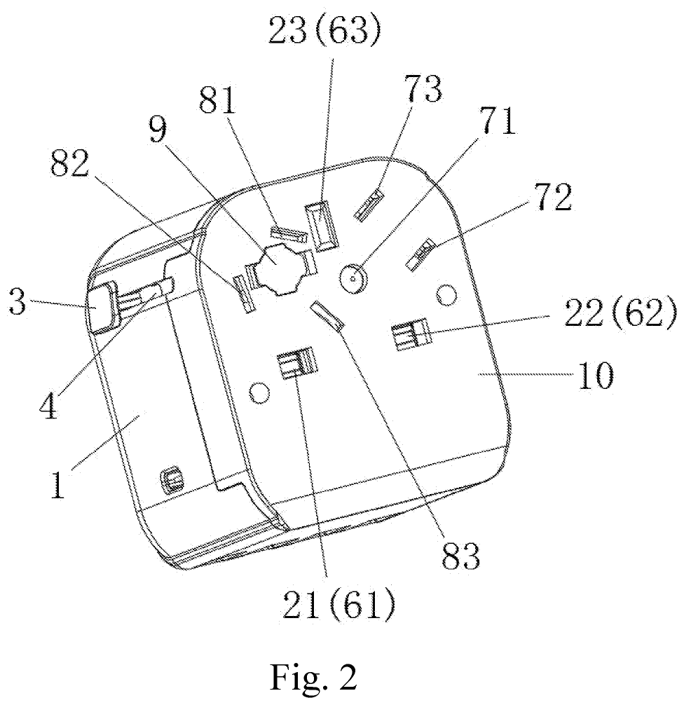

Referring to FIGS. 1 and 2, an embodiment of the present invention provides a small sliding multiple plug comprising a housing 1 and a plurality of pin holes 2 provided on the bottom surface of the housing 1. Multiple national standards of pins can be retained in the housing 1, and can be made in combination according to specific requirements; and the shape of the pin hole 2 is a corresponding hole shape according to the requirements of a specific standard. Meanwhile, the side surface of the housing 1 is provided with a push key 3 and a sliding groove 4, wherein the push key 3 can drive a corresponding standard of pin to move along the sliding groove 4 which can play the role of guiding and controlling the displacement distance.

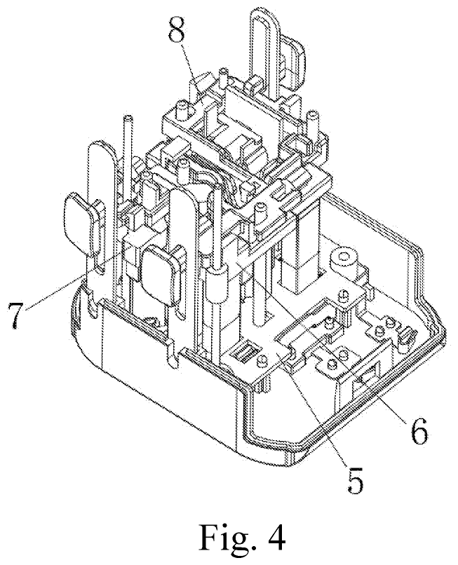

In the present embodiment, as shown in FIGS. 2 and 4, a first pin 6, a second pin 7 and a third pin 8 are arranged in the housing 1, wherein the first pin 6 mainly consists of a ground line leg 63, a live line leg 61 and a null line leg 62; when the ground line leg 63 of the first pin 6 is taken as a central point, the second pin 7 is arranged on one side of the central point, and the third pin 8 is arranged on the other side of the central point; and the second pin 7 and the third pin 8 are respectively composed of three legs including the ground line leg. Meanwhile, the second pin (7) and the third pin (8) are both located on the upper sides of the live line leg (61) and the null line leg (62) of the first pin (6). By arranging the second pin 7 and the third pin 8 on shoulders of both sides of the first pin 6, the space on the shoulders of both sides of the first pin 6 is effectively used, so that the volume of the small plug of the whole converter can be further reduced, facilitating the development of the product to be miniaturized and convenient to carry. Meanwhile, the first pin 6, the second pin 7 and the third pin 8 all contain the ground line leg. When they are used in a high-power electric appliance, there is no risk of electric shock and leakage, with high safety, which meets the safety standards. Therefore, the use safety of the product is greatly improved while reducing the volume of the product. Moreover, the legs can be pushed out and pushed in without crossing each other, so that the operation is smooth and practical.

Specifically, as shown in FIG. 1, the pin hole 2 comprises a first leg hole 21 through which a live line leg 61 passes, a second leg hole 22 through which a null line leg 62 passes, and a third leg hole 23 through which a ground line leg 63 passes, wherein the third leg hole 23 is perpendicularly arranged on one side of the midpoint of the first leg hole 21 and the second leg hole 22, and the first leg hole 21, the second leg hole 22 and the third leg hole 23 are arranged on the housing 1 at a relatively central position.

Specifically, as shown in FIG. 1, the bottom surface 10 of the housing 1 comprises a first bottom edge 101, a second bottom edge 102 and a third bottom edge 103; a first region 613 and a second region 623 are formed on two shoulders of the first leg hole 21 and the second leg hole 22, namely, the ground line leg 63, wherein the first region 613 is constituted by a closed loop of the first bottom edge 101, the second bottom edge 102, a parallel line passing through the first leg hole 21 and parallel to the first bottom edge 101, and a parallel line passing through the third leg hole 23 and parallel to the second bottom edge 102; and the second region 623 constituted by a closed loop of the first bottom edge 101, a third bottom edge 103, a parallel line passing through the second leg hole 22 and parallel to the first bottom edge 101, and a parallel line passing through the third leg hole 23 and parallel to the third bottom edge 103. Thus, the first region (613) and the second region (623) are provided on both sides of the ground line leg (63), respectively. Specifically, the second pin 7 and the corresponding pin hole are disposed in the first region 613, and the third pin 8 and the corresponding pin hole are disposed in the second region 623.

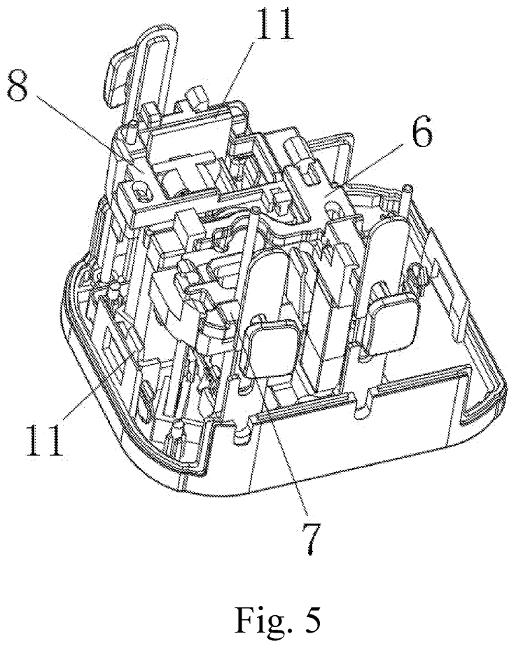

In the present embodiment, in order to increase the ground line legs of the second pin 7 and the third pin 8 in a limited space so as to improve the safety in use, the gap between the legs needs to be made small while ensuring that the gap between each two legs can meet the safety clearance. As shown in FIG. 5, the present embodiment is provided with at least one retaining wall 11 extended in the housing 1, and the retaining wall 11 is located on the side of at least one of the first pin 6, the second pin 7 and the third pin 8. By spacing the two legs apart by the retaining wall 6 so that the creepage distance between the two legs increases, thereby increasing the electrical clearance between the two legs, the legs meet the safety regulations. Thus, the entire product has both advantages of meeting the safety standard and being small in size, so that the product can be miniaturized while meeting the safety standard.

However, with regard to the specific position of the retaining wall 11, it can be located between the null line leg and the live line leg in the first pin 6, the second pin 7 and the third pin 8. The specific number of retaining walls 11 can be set according to specific needs.

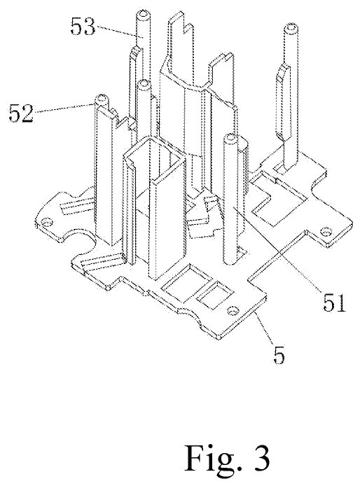

As shown in FIGS. 3 and 4, a positioning guide seat 5 (the mounting seat can be provided separately or directly integrally formed with the housing) is provided in the housing 1 (no electrical components such as a circuit board, a capacitor, a conductive sheet and a safety valve are shown); a first pin 6, a second pin 7 and a third pin 8 are matchingly provided on the positioning guide seat 5 which is provided with a UK standard of limiting guide post 51, a US standard of limiting guide post 52 and an AU-CN standard of limiting guide post 53 for positioning, guiding and limiting; the second pin 7 and the third pin 8 are respectively provided in the first region 613 and the second region 623 formed by two shoulders of the first pin 6; and the positions of the second pin 7 and the second pin 8 are interchangeable.

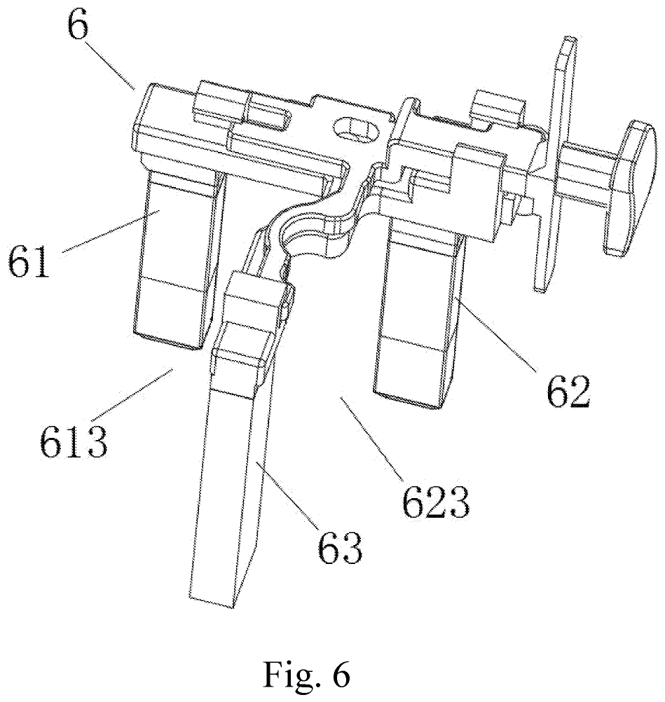

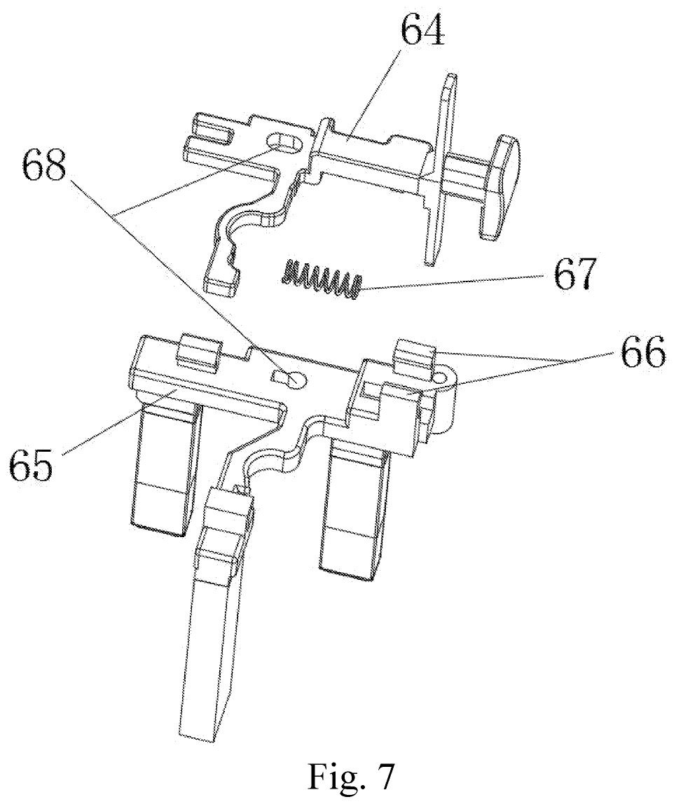

As shown in FIGS. 6 and 7, the first pin 6 is a UK standard of pin, comprising a live line leg 61, a null line leg 62, a ground line leg 63, a UK standard of sliding piece 64 and a UK standard of pin seat 65; the UK standard of pin seat 65 is provided with a UK standard of clamping mechanism 66 and a UK standard of return spring, and the UK standard of sliding piece 64 is clamped and movable in the UK standard of clamping mechanism 66; the live line leg 61, null line leg 62 and ground line leg 63 are provided below the UK standard of pin seat 65; and the UK standard of sliding piece 64 and the UK standard of pin seat 65 are provided with a UK standard of positioning hole 68 matched with the UK standard of limiting guide post 51 to control the pushing-out and pushing-in of the first pin 6.

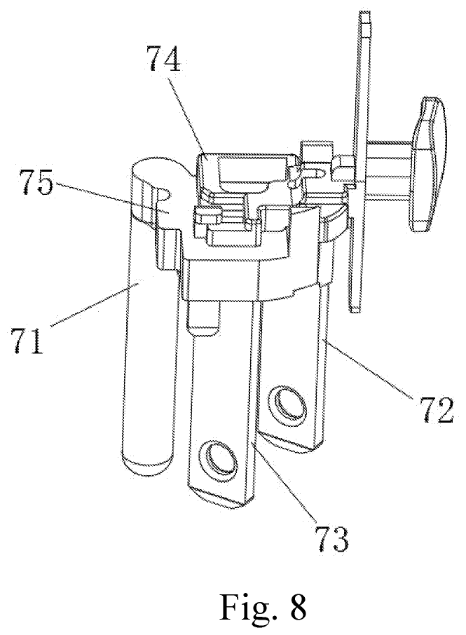

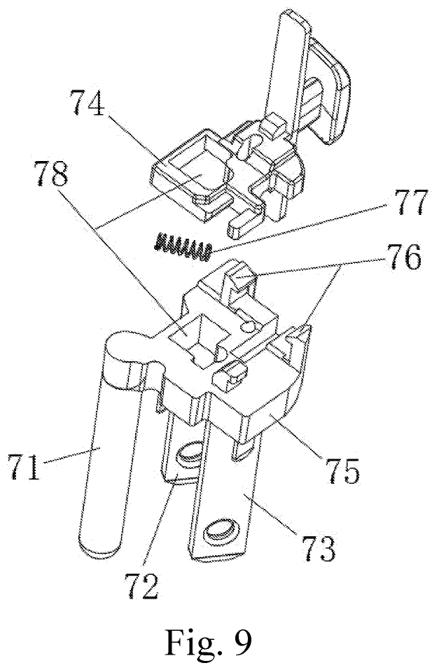

As shown in FIGS. 8 and 9, the second pin 7 is a US standard of pin, comprising a fourth leg 71, a fifth leg 72, a sixth leg 73, a US standard of sliding piece 74 and a US standard of pin seat 75, wherein at least one of the fourth leg 71, the fifth leg 72 and the sixth leg 73 is a ground line leg, and the other two are a live line leg and a null line leg, respectively; the fourth leg 71 faces towards the middle point of the first leg hole 21 and the second leg hole 22; the US standard of pin seat 75 is provided with a US standard of clamping mechanism 76 and a US standard of return spring 77, and the US standard of sliding piece 74 is clamped and movable in the US standard of clamping mechanism 76; the fourth leg 71, the fifth leg 72 and the sixth leg 73 are arranged below the US standard of pin seat 75; and the US standard of sliding piece 74 and the US standard of pin seat 75 are provided with a US standard of positioning hole 78 matched with the US standard of limiting guide post 52 to control the pushing-out and pushing-in of the second pin 7 so as to play a guiding role.

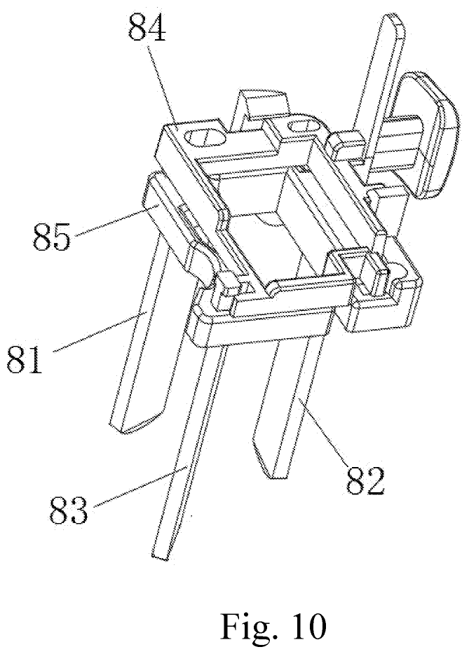

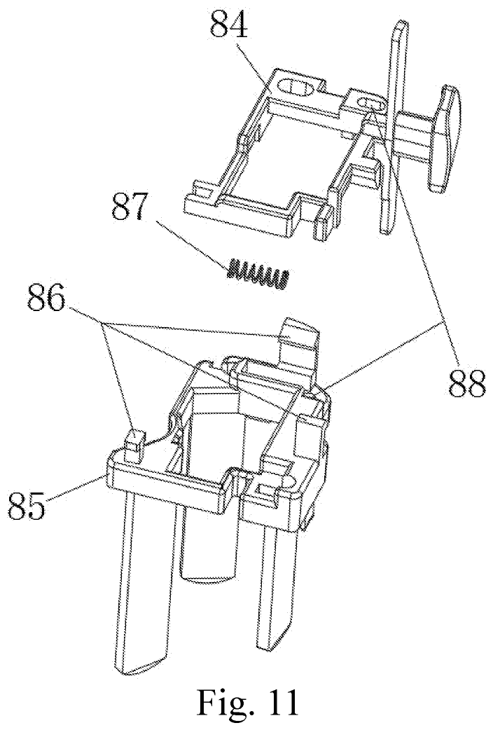

As shown in FIGS. 10 and 11, the third pin 8 is an AU standard or CN standard of pin, comprising a seventh leg 81, an eighth leg 82, a ninth leg 83, an AU-CN sliding piece 84 and an AU-CN pin seat 85, wherein at least one of the seventh leg 81, the eighth leg 82 and the ninth leg 83 is a ground line leg, the other two are a live line leg and a null line leg, respectively, and the ninth leg 83 faces towards the midpoint of the first leg hole 21 and the second leg hole 22; the AU-CN pin seat 85 is provided with an AU-CN clamping mechanism 86 and an AU-CN return spring 87, and the AU-CN sliding piece 84 is clamped and movable in the AU-CN pin seat 85; the seventh leg 81, the eighth leg 82 and the ninth leg 83 are provided below the AU-CN pin seat 85; and the AU-CN sliding piece 84 and the AU-CN pin seat 85 are provided with an AU-CN positioning hole 88 matched with the AU-CN limiting guide post 53 to control the pushing-out and pushing-in of the third pin 8 so as to play a guiding role.

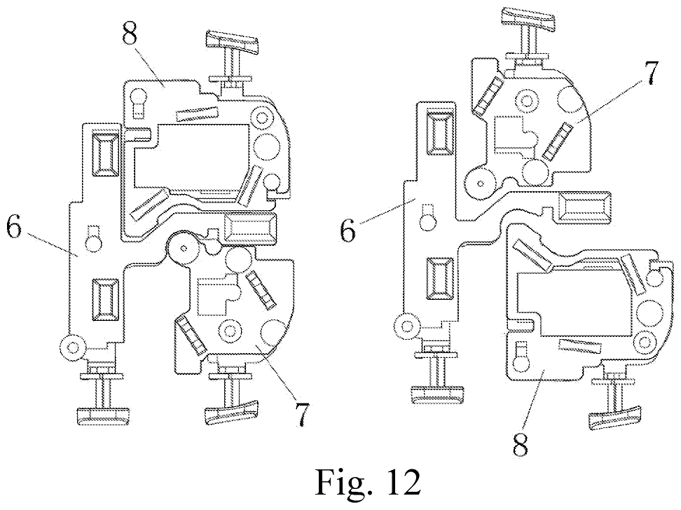

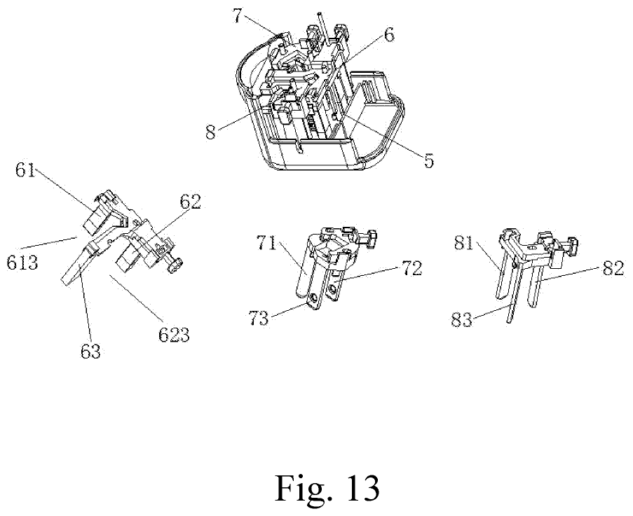

As shown in FIGS. 12 and 13, the principles and possible configurations of this embodiment and other shapes of pins are included.

The first pin 6 is a UK standard of pin, the ground line leg 63 is provided in the middle, and a US standard of pin and an AU (CN) standard of pin are respectively provided on both sides of the ground line leg 63; the positions of the pins on the both sides can be interchanged, and the first pin 6 is T-shaped; the second pin 7 may be C-shaped or L-shaped or O-shaped; and the third pin 8 may be C-shaped, L-shaped, D-shaped or O-shaped.

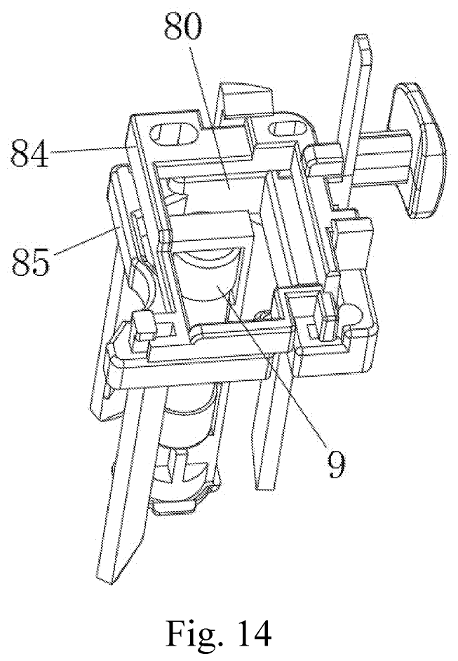

In this embodiment, as shown in FIG. 14, a fuse 9 is provided in the housing 1 among three legs of the third pin 8, i. e. among the seventh leg 81, the eighth leg 82 and the ninth leg 83; meanwhile, an opening 80 through which the fuse 9 passes is formed in the AU-CN standard of sliding piece 84 and the AU-CN standard of pin seat 85, and the lower end of the fuse 9 extends to the bottom surface 10 of the housing 1, as shown in FIG. 2. The fuse 9 is added in the housing 1 with a small limited space, and is cleverly arranged among three legs of the third pin 8, so as to further improve the electric safety and meet the safety standards on the basis of ensuring the overall miniaturization of the product.

In this embodiment, the US standard of pin or the AU standard (or CN standard) of pin are provided at both shoulders of the UK standard of pin at the same time to effectively use the space of the shoulders at both sides of the UK standard of pin, so that the volume of the small plug of the whole converter can be further reduced, facilitating the development of the product to be miniaturized and convenient to carry. Specifically, the volume of the product can be reduced by about 30%. When they are used in high-power electrical appliances, there is no risk of electric shock and leakage, with high safety, which meets the safety standards. Specifically, it conforms to IEC 60884 and BS8546 standards.

Meanwhile, in the small sliding multiple plug disclosed in the present embodiment, the distance from the US standard of pin to the edge of the housing 1 is greater than 5.1 mm, i. e. meeting the UL1310 security standard. At the same time, when the UK standard of pin is pushed out for use, the distance between the UK standard of pin and the edge of housing 1 can ensure that it can be inserted into the British socket for normal use, i. e. meeting the British BS1363 gauge standard.

In the description above, only the preferred embodiments of the present invention has been described, and the technical scope of the present invention is not limited in any way. Therefore, other structures obtained by adopting the same or similar technical features as those of the above embodiments of the present invention are within the scope of the present invention.

1. A small sliding multiple plug, comprising a housing (1), and a plurality of pin holes (2) arranged on the bottom surface of the housing (1), characterized in that a first pin (6), a second pin (7) and a third pin (8) are arranged in the housing (1), wherein the first pin (6) mainly consists of a ground line leg (63), a live line leg (61) and a null line leg (62); when the ground line leg (63) of the first pin (6) is taken as a central point, the second pin (7) is arranged on one side of the central point, and the third pin (8) is arranged on the other side of the central point; and the second pin (7) and the third pin (8) are respectively composed of three legs including the ground line leg.

2. The small sliding multiple plug according to claim 1, characterized in that at least one retaining wall (11) is extended in the housing (1) on the side of at least one of the first pin (6), the second pin (7) and the third pin (8).

3. The small sliding multiple plug according to claim 1, characterized in that the second pin (7) and the third pin (8) are both located on the upper sides of the live line leg (61) and the null line leg (62) of the first pin (6).

4. The small sliding multiple plug according to claim 1, characterized in that the first pin (6) is T-shaped; the second pin (7) is C-shaped, L-shaped or O-shaped; and the third pin (8) is C-shaped, L-shaped, D-shaped or O-shaped.

5. The small sliding multiple plug according to claim 1, characterized in that a fuse (9) is arranged in the housing (1) among the three legs of the third pin (8).

6. The small sliding multiple plug according to claim 1, characterized in that the first pin (6) is a UK standard of pin; the second pin (7) is a US standard of pin; and the third pin (8) is an AU standard of pin or a CN standard of pin.

7. The small sliding multiple plug according to claim 1, characterized in that the pin hole (2) comprises a first leg hole (21) through which a live line leg (61) passes, a second leg hole (22) through which a null line leg (62) passes, and a third leg hole (23) through which a ground line leg (63) passes; the third leg hole (23) is perpendicularly arranged at one side of the middle point of the first leg hole (21) and the second leg hole (22); a bottom surface (10) of the housing (1) comprises a first bottom edge (101), a second bottom edge (102) and a third bottom edge (103), wherein a first region (613) is constituted by the first bottom edge (101), a second bottom edge (102), a parallel line passing through the first leg hole (21) and being parallel to the first bottom edge (101), and a parallel line passing through the third leg hole (23) and being parallel to the second bottom edge (102); a second region (623) is constituted by the first bottom edge (101), a third bottom edge (103), a parallel line passing through the second foot hole (22) and being parallel to the first bottom edge (101), and a parallel line passing through the third foot hole (23) and being parallel to the third bottom edge (103); the first region (613) and the second region (623) are respectively provided on both sides of the ground line leg (63); the second pin (7) and the corresponding pin hole are arranged in the first region (613), and the third pin (8) and the corresponding pin hole are arranged in the second region (623); the second pin (7) comprises a fourth leg (71), a fifth leg (72) and a sixth leg (73), and at least one of the fourth leg (71), the fifth leg (72) and the sixth leg (73) is a ground line leg; the third pin (8) comprises a seventh leg (81), an eighth leg (82) and a ninth leg (83), wherein at least one of the seventh leg (81), the eighth leg (82) and the ninth leg (83) is a ground line leg; and positioning guide seats (5) are provided in the housing (1) to match the first pin (6), the second pin (7) and the third pin (8), respectively.

8. The small sliding multiple plug according to claim 7, characterized in that the fourth leg (71) is directed towards a midpoint of the first leg hole (21) and the second leg hole (22); and the ninth leg (83) is directed towards a midpoint of the first leg hole (21) and the second leg hole (22).

9. The small sliding multiple plug according to claim 7, characterized in that the first pin (6) further comprises a UK standard of sliding piece (64) and a UK standard of pin seat (65), wherein the UK standard of pin seat (65) is provided with a UK standard of clamping mechanism (66) and a UK standard of return spring (67), and the UK standard of sliding piece (64) is clamped and movable in the UK standard of clamping mechanism (66); the UK standard of sliding piece (64) and the UK standard of pin seat (65) are provided with a UK standard of positioning hole (68); a UK standard of limiting guide post (51) is provided at a corresponding position of the positioning guide seat (5); and the pushing-out and pushing-in of the first pin (6) is controlled by the matching of the UK standard of positioning hole (68) and the UK standard of limiting guide post (51).

10. The small sliding multiple plug according to claim 7, characterized in that the second pin (7) comprises a US standard of sliding piece (74) and a US standard of pin seat (75); the US standard of pin seat (75) is provided with a US standard of clamping mechanism (76) and a US standard of return spring (77); the US standard of sliding piece (74) is clamped and movable in the US standard of clamping mechanism (76); the US standard of sliding piece (74) and the US standard of pin seat (75) are provided with a US standard of positioning hole (78); a US standard of limiting guide post (52) is provided at a corresponding position of the positioning guide seat (5); and the pushing-out and pushing-in of the second pin (7) is controlled by the matching of the US standard of positioning hole (78) and the US standard of limiting guide post (52).

11. The small sliding multiple plug according to claim 7, characterized in that the third pin (8) comprises an AU-CN sliding piece (84) and an AU-CN pin seat (85); the AU-CN pin seat (85) is provided with an AU-CN clamping mechanism (86) and an AU-CN return spring (87); the AU-CN sliding piece (84) is clamped and movable in the AU-CN clamping mechanism (86); the AU-CN sliding piece (84) and the AU-CN pin seat (85) are provided with an AU-CN positioning hole (88); an AU-CN limiting guide post (53) is provided at a corresponding position of the positioning guide seat (5); and the pushing-out and pushing-in of the third pin (8) is controlled by the matching of the AU-CN positioning hole (88) and AU-CN limiting guide post (53).
